(19) United States
(12) Patent Application Publication
(10) Pub. No.: US 2022/0299340 A1
(43) Pub. Date: Sep. 22, 2022

(54) MAP INFORMATION GENERATION APPARATUS

(71) Applicant: Honda Motor Co., Ltd., Tokyo (JP)

(72) Inventor: Hayato Ikeda, Wako-shi (JP)

(21) Appl. No.: 17/676,574

(22) Filed: Feb. 21, 2022

(30) Foreign Application Priority Data
Mar. 17, 2021 (JP) 2021-043046

(51) Int. Cl. G01C 21/00

(52) U.S. Cl. CPC G01C 21/3807; G01C 21/3848

(57) ABSTRACT

A map information generation apparatus including a detection device detecting an external situation around a subject vehicle and an electronic control unit including a microprocessor and a memory. The microprocessor is configured to perform recognizing a landmark around the subject vehicle, based on an information on the external situation detected by the detection device in a first time zone, and determining whether the landmark recognized in the first time zone is recognized in a second time zone different from the first time zone, based on the information on the external situation detected by the detection device in the second time zone. The memory is configured to store the information on the landmark recognized in the first time zone, in accordance with a determination result of whether the landmark recognized in the first time zone is recognized in the second time zone.

### CROSS-REFERENCE TO RELATED APPLICATION

This application is based upon and claims the benefit of priority from Japanese Patent Application No. 2021-043046 filed on Mar. 17, 2021, the content of which is incorporated herein by reference.

### BACKGROUND OF THE INVENTION

### Field of the Invention

This invention relates to a map information generation apparatus configured to generate a map information for a vehicle, and a vehicle position estimation apparatus including the map information generation apparatus.

### Description of the Related Art

Conventionally, there is a known apparatus that compares a peripheral image captured by an in-vehicle camera with a position image, which is a scenery image at each position preliminarily registered in a database, selects a position image highly similar to the peripheral image, and estimates a position corresponding to the selected image as a vehicle position. Such an apparatus is described, for example, in Japanese Unexamined Patent Publication No. 2019-196981 (JP2019-196981A).

When a vehicle travels in different time zones, however, captured scenery images may be different from each other even if the vehicle travels through the same point. The configuration of the apparatus described in JP2019-196981A thus has difficulty in accurately estimating a vehicle position.

### SUMMARY OF THE INVENTION

An aspect of the present invention is a map information generation apparatus generating a map information including an information on a landmark, and the map information generation apparatus includes a detection device that detects an external situation around a subject vehicle, and an electronic control unit including a microprocessor and a memory connected to the microprocessor. The microprocessor is configured to perform recognizing the landmark around the subject vehicle, based on an information on the external situation detected by the detection device in a first time zone, and determining whether the landmark recognized in the first time zone is recognized in a second time zone different from the first time zone, based on the information on the external situation detected by the detection device in the second time zone. The memory is configured to store the information on the landmark recognized in the first time zone, in accordance with a determination result of whether the landmark recognized in the first time zone is recognized in the second time zone.

Another aspect of the present invention is a vehicle position estimation apparatus including the above map information generation apparatus. The microprocessor is configured to perform estimating a position of the subject vehicle based on the map information generated by the map information generation apparatus.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an overall configuration of a vehicle control system in a self-driving vehicle having a map information generation apparatus according to an embodiment of the present invention;

FIG. 2A is a view illustrating an example of a camera image acquired by an on-board camera of the subject vehicle having the map information generation apparatus according to the embodiment of the present invention;

FIG. 2B is a view illustrating another example of the camera image acquired by the on-board camera of the subject vehicle having the map information generation apparatus according to the embodiment of the present invention;

FIG. 3 is a block diagram illustrating a configuration of a substantial part of a vehicle position estimation apparatus according to the embodiment of the invention;

FIG. 4 is a flowchart illustrating an example of processing executed by a controller in FIG. 3;

FIG. 5 a view illustrating an example of time information added to the landmark information, acquired by the map information generation apparatus according to the embodiment of the present invention; and

FIG. 6 is a flowchart illustrating a variation of FIG. 4.

### DETAILED DESCRIPTION OF THE INVENTION

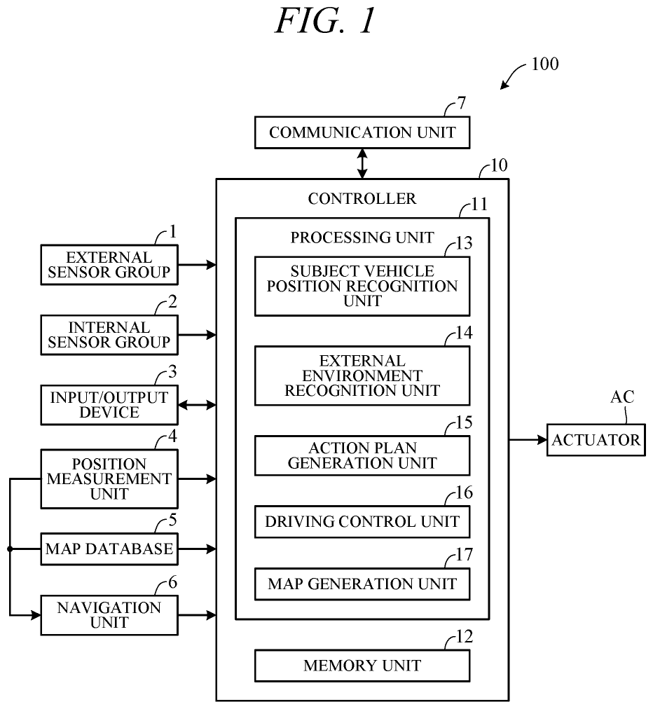

Hereinafter, an embodiment of the present invention is explained with reference to FIGS. 1 to 6. A map information generation apparatus according to an embodiment of the invention is configured as an apparatus generating a map information used by a vehicle having a self-driving capability, i.e., a self-driving vehicle. The map information generation apparatus can be also used by a manual driving vehicle. In the following, an example of the self-driving vehicle having the map information generation apparatus will be explained.

The vehicle having the map information generation apparatus may be sometimes called “subject vehicle” to differentiate it from other vehicles. The subject vehicle is an engine vehicle having an internal combustion engine (engine) as a travel drive source, electric vehicle having a travel motor as the travel drive source, or hybrid vehicle having both of the engine and the travel motor as the travel drive source. The subject vehicle can travel not only in a self-drive mode in which a driving operation by a driver is unnecessary, but also in a manual drive mode in which the driving operation by the driver is necessary.

First, the general configuration of the subject vehicle for self-driving will be explained. FIG. 1 is a block diagram schematically illustrating an overall configuration of a vehicle control system 100 of the subject vehicle having the map information generation apparatus according to an embodiment of the present invention. As shown in FIG. 1, the vehicle control system 100 mainly includes a controller 10, and an external sensor group 1, an internal sensor group 2, an input/output device 3, a position measurement unit 4, a map database 5, a navigation unit 6, a communication unit 7 and actuators AC which are communicably connected with the controller 10.

The term external sensor group 1 herein is a collective designation encompassing multiple sensors (external sensors) for detecting external circumstances constituting subject vehicle ambience data. For example, the external sensor group 1 includes, inter alia, a LIDAR (Light Detection and Ranging) for measuring distance from the subject vehicle to ambient obstacles by measuring scattered light produced by laser light radiated from the subject vehicle in every direction, a RADAR (Radio Detection and Ranging) for detecting other vehicles and obstacles around the subject vehicle by radiating electromagnetic waves and detecting reflected waves, and a CCD, CMOS or other image sensor-equipped on-board cameras for imaging subject vehicle ambience (forward, reward and sideways).

The term internal sensor group 2 herein is a collective designation encompassing multiple sensors (internal sensors) for detecting driving state of the subject vehicle. For example, the internal sensor group 2 includes, inter alia, a vehicle speed sensor for detecting vehicle speed of the subject vehicle, acceleration sensors for detecting forward-rearward direction acceleration and lateral acceleration of the subject vehicle, respectively, rotational speed sensor for detecting rotational speed of the travel drive source, a yaw rate sensor for detecting rotation angle speed around a vertical axis passing center of gravity of the subject vehicle and the like. The internal sensor group 2 also includes sensors for detecting driver driving operations in manual drive mode, including, for example, accelerator pedal operations, brake pedal operations, steering wheel operations and the like.

The term input/output device 3 is used herein as a collective designation encompassing apparatuses receiving instructions input by the driver and outputting information to the driver. The input/output device 3 includes, inter alia, switches which the driver uses to input various instructions, a microphone which the driver uses to input voice instructions, a display for presenting information to the driver via displayed images, and a speaker for presenting information to the driver by voice.

The position measurement unit (GNSS unit) 4 includes a position measurement sensor for receiving signal from positioning satellites to measure the location of the subject vehicle. The position measurement sensor may be included in the internal sensor group 2. The positioning satellites are satellites such as GPS satellites and Quasi-Zenith satellite. The position measurement unit 4 measures absolute position (latitude, longitude and the like) of the subject vehicle based on signal received by the position measurement sensor.

The map database 5 is a unit storing general map data used by the navigation unit 6 and is, for example, implemented using a magnetic disk or semiconductor element. The map data include road position data and road shape (curvature etc.) data, along with intersection and road branch position data. The map data stored in the map database 5 are different from high-accuracy map data stored in a memory unit 12 of the controller 10.

The navigation unit 6 retrieves target road routes to destinations input by the driver and performs guidance along selected target routes. Destination input and target route guidance is performed through the input/output device 3. Target routes are computed based on current position of the subject vehicle measured by the position measurement unit 4 and map data stored in the map database 35. The current position of the subject vehicle can be measured, using the values detected by the external sensor group 1, and on the basis of this current position and high-accuracy map data stored in the memory unit 12, target route may be calculated.

The communication unit 7 communicates through networks including the Internet and other wireless communication networks to access servers (not shown in the drawings) to acquire map data, travel history information of other vehicle, traffic data and the like, periodically or at arbitrary times. In addition to acquiring travel history information of the other vehicle, travel history information of the subject vehicle may be transmitted to the server via the communication unit 7. The networks include not only public wireless communications network, but also closed communications networks, such as wireless LAN, Wi-Fi and Bluetooth, which are established for a predetermined administrative area. Acquired map data are output to the map database 5 and/or memory unit 12 via the controller 10 to update their stored map data.

The actuators AC are actuators for traveling of the subject vehicle. If the travel drive source is the engine, the actuators AC include a throttle actuator for adjusting opening angle of the throttle valve of the engine (throttle opening angle). If the travel drive source is the travel motor, the actuators AC include the travel motor. The actuators AC also include a brake actuator for operating a braking device and turning actuator for turning the front wheels FW.

The controller 10 is constituted by an electronic control unit (ECU). More specifically, the controller 10 incorporates a computer including a CPU or other processing unit (a microprocessor) 51 for executing a processing in relation to travel control, the memory unit (a memory) 12 of RAM, ROM and the like, and an input/output interface or other peripheral circuits not shown in the drawings. In FIG. 1, the controller 10 is integrally configured by consolidating multiple function-differentiated ECUs such as an engine control ECU, a transmission control ECU and so on. Optionally, these ECUs can be individually provided.

The memory unit 12 stores high-accuracy detailed road map data (road map information). The road map information includes information on road position, information on road shape (curvature, etc.), information on gradient of the road, information on position of intersections and branches, information on the number of lanes, information on width of lane and the position of each lane (center position of lane and boundary line of lane), information on position of landmarks (traffic lights, signs, buildings, etc.) as a mark on the map, and information on the road surface profile such as unevennesses of the road surface, etc. The information on the landmark (landmark information) includes information such as the shape (outline), characteristics, and position of the landmark. The information on the characteristics of a landmark relates to whether or not the appearance of the landmark changes depending on a time zone, weather, or climate, and a form of change in the case where the appearance changes, for example.

The map information stored in the memory unit 12 includes map information (referred to as external map information) acquired from the outside of the subject vehicle through the communication unit 7, and map information (referred to as internal map information) created by the subject vehicle itself using the detection values of the external sensor group 1 or the detection values of the external sensor group 1 and the internal sensor group 2. The external map information is, for example, information of a map (called a cloud map) acquired through a cloud server, and the internal map information is information of a map (called an environment map) consisting of point cloud data generated by mapping using a technique such as SLAM (Simultaneous Localization and Mapping). The external map information is shared by the subject vehicle and other vehicles, whereas the internal map information is unique map information of the subject vehicle (e.g., map information that the subject vehicle has alone).

The memory unit 12 also stores information on various control programs and thresholds used in the programs. The memory unit 12 further stores travel history information on the subject vehicle, which has been acquired by the internal sensor group 2, in association with highly accurate map information (e.g., environment map information). The travel history information indicates that in what mode the subject vehicle traveling by manual driving traveled on a road in the past. Information such as a travel route and travel date and time and information such as a vehicle speed and the level of acceleration/deceleration are stored as the travel history information in association with road position information.

As functional configurations in relation to mainly self-driving, the processing unit 11 includes a subject vehicle position recognition unit 13, an external environment recognition unit 14, an action plan generation unit 15, a driving control unit 16, and a map generation unit 17.

The subject vehicle position recognition unit 13 recognizes the position of the subject vehicle (subject vehicle position) on the map based on position information of the subject vehicle calculated by the position measurement unit 4 and map information stored in the map database 5. Optionally, the subject vehicle position can be recognized using map information stored in the memory unit 12 and ambience data of the subject vehicle detected by the external sensor group 1, whereby the subject vehicle position can be recognized with high accuracy. For example, the subject vehicle position recognition unit 13 identifies a landmark included in the camera image, by comparing image information acquired by the camera during traveling with landmark image information preliminarily stored in the memory unit 12. Based on the identified landmark, the subject vehicle position can be recognized. Optionally, when the subject vehicle position can be measured by sensors installed externally on the road or by the roadside, the subject vehicle position can be recognized by communicating with such sensors through the communication unit 7.

The external environment recognition unit 14 recognizes external circumstances around the subject vehicle based on signals from cameras, LIDERs, RADARs and the like of the external sensor group 1. For example, it recognizes position, speed and acceleration of nearby vehicles (forward vehicle or rearward vehicle) driving in the vicinity of the subject vehicle, position of vehicles stopped or parked in the vicinity of the subject vehicle, and position and state of other objects. Other objects include traffic signs, traffic lights, road division lines (white lines, etc.) and stop lines, buildings, guardrails, power poles, commercial signs, pedestrians, bicycles, and the like. Recognized states of other objects include, for example, traffic light color (red, green or yellow) and moving speed and direction of pedestrians and bicycles. A part of a stationary object among other objects, constitutes a landmark serving as an index of position on the map, and the external environment recognition unit 14 also recognizes the position and type of the landmark.

The action plan generation unit 15 generates a driving path (target path) of the subject vehicle from present time point to a certain time ahead based on, for example, a target route computed by the navigation unit 6, map information stored in the memory unit 12, subject vehicle position recognized by the subject vehicle position recognition unit 13, and external circumstances recognized by the external environment recognition unit 14. When multiple paths are available on the target route as target path candidates, the action plan generation unit 15 selects from among them the path that optimally satisfies legal compliance, safe efficient driving and other criteria, and defines the selected path as the target path. The action plan generation unit 15 then generates an action plan matched to the generated target path. An action plan is also called “travel plan”. The action plan generation unit 15 generates various kinds of action plans corresponding to overtake traveling for overtaking the forward vehicle, lane-change traveling to move from one traffic lane to another, following traveling to follow the preceding vehicle, lane-keep traveling to maintain same lane, deceleration or acceleration traveling. When generating a target path, the action plan generation unit 15 first decides a drive mode and generates the target path in line with the drive mode.

In self-drive mode, the driving control unit 16 controls the actuators AC to drive the subject vehicle along target path generated by the action plan generation unit 15. More specifically, the driving control unit 16 calculates required driving force for achieving the target accelerations of sequential unit times calculated by the action plan generation unit 15, taking running resistance caused by road gradient and the like into account. And the driving control unit 16 feedback-controls the actuators AC to bring actual acceleration detected by the internal sensor group 2, for example, into coincidence with target acceleration. In other words, the driving control unit 16 controls the actuators AC so that the subject vehicle travels at target speed and target acceleration. On the other hand, in manual drive mode, the driving control unit 16 controls the actuators AC in accordance with driving instructions by the driver (steering operation and the like) acquired from the internal sensor group 2.

The map generation unit 17 generates the environment map constituted by three-dimensional point cloud data using detection values detected by the external sensor group 1 during traveling in the manual drive mode. Specifically, an edge indicating an outline of an object is extracted from a camera image acquired by the camera based on luminance and color information for each pixel, and a feature point is extracted using the edge information. The feature point is, for example, an intersection of the edges, and corresponds to a corner of a building, a corner of a road sign, or the like. The map generation unit 17 sequentially plots the extracted feature point on the environment map, thereby generating the environment map around the road on which the subject vehicle has traveled. The environment map may be generated by extracting the feature point of an object around the subject vehicle using data acquired by radar or LIDAR instead of the camera.

The subject vehicle position recognition unit 13 performs subject vehicle position estimation processing in parallel with map creation processing by the map generation unit 17. That is, the position of the subject vehicle is estimated based on a change in the position of the feature point over time. The map creation processing and the position estimation processing are simultaneously performed, for example, according to an algorithm of SLAM. The map generation unit 17 can generate the environment map not only when the vehicle travels in the manual drive mode but also when the vehicle travels in the self-drive mode. If the environment map has already been generated and stored in the memory unit 12, the map generation unit 17 may update the environment map with a newly obtained feature point.

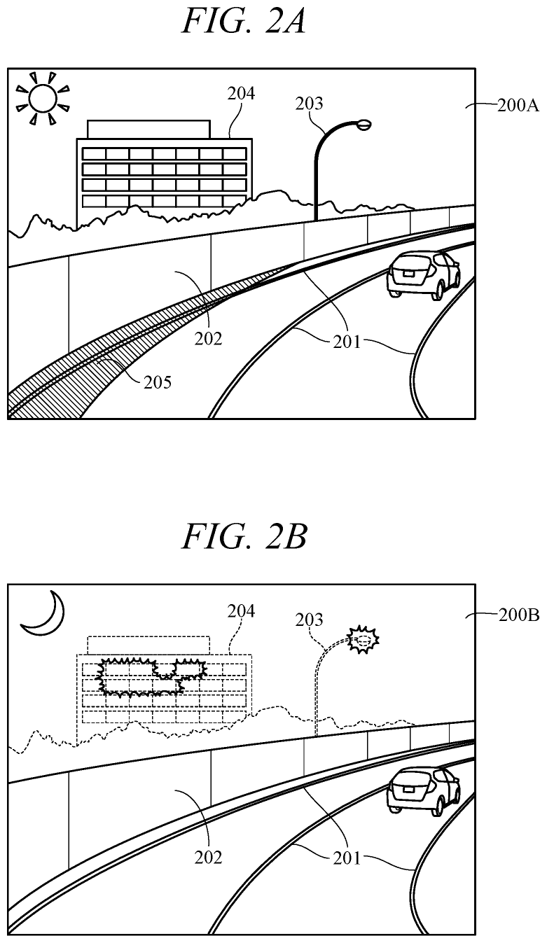

The characteristic configuration of the map information generation apparatus according to the present embodiment will be described. FIGS. 2A and 2B are images each captured by a camera (in-vehicle camera) of the subject vehicle including the map information generation apparatus. In particular, FIG. 2A is a camera image 200A captured when the subject vehicle traveled during the daytime (day) (referred to as daytime image). FIG. 2B is a camera image 200B captured when the subject vehicle traveled through the same point at night (referred to as nighttime image). Note that the daytime is a time zone from sunrise to sunset, for example. The nighttime is a time zone from sunset to sunrise, for example.

As illustrated in FIG. 2A, a division line image 201, a sidewall image 202, a streetlight image 203, a building image 204, and a shadow image 205 can be obtained from the daytime image 200A. The division line image 201 represents a division line. The sidewall image 202 represents a sidewall of a road. The streetlight image 203 represents a streetlight facing the road. The building image 204 represents the outline and windows of a building. The shadow image 205 represents a shadow (hatching) of the sidewall. A plurality of landmarks can thus be set by using these characteristic points on the images. Landmark information can be generated. In the landmark information, each of the division line, the sidewall, the streetlight, the building, and the shadow serves as a landmark.

In contrast, as illustrated in FIG. 2B, the division line image 201 and the sidewall image 202 can be obtained from the nighttime image 200B. The streetlight is turn off at daytime, but turned on at night. Further, the windows of the building are also illuminated by illumination. Therefore, it is difficult to clearly recognize the outlines of the streetlight and the building from the camera image. The streetlight image 203 and the building image 204 similar to those obtained from the daytime image 200A cannot thus be obtained from the nighttime image 200B. Since the sunlight generates no shadow at night, the shadow image 205 cannot also be obtained from the nighttime image 200B. Although landmark information on the division line and the sidewall can be generated from the nighttime image 200B, landmark information on the streetlight, the building, and the shadow cannot be generated.

As described above, the camera recognizes different landmarks between daytime and nighttime. The subject vehicle position recognition unit 13 (FIG. 1) has thus difficulty in estimating a subject vehicle position at night based on information on, for example, a landmark recognized only during the day (e.g., streetlight and shadow). The subject vehicle position recognition unit 13 cannot satisfactorily estimate the subject vehicle position in this case. In the present embodiment, a vehicle position estimation apparatus is configured as follows so that the subject vehicle position can be satisfactorily estimated based on a landmark regardless of a time zone such as day and night.

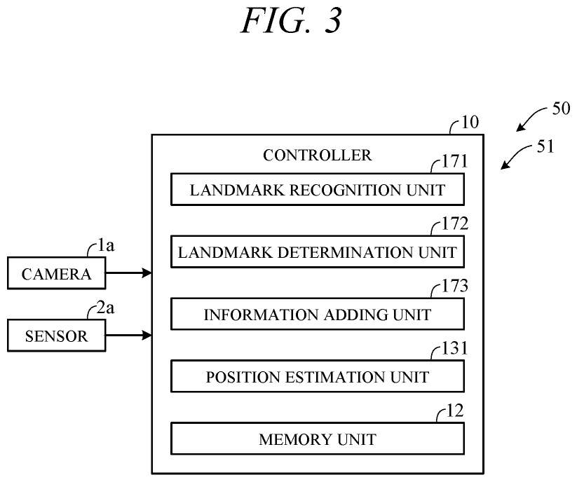

FIG. 3 is a block diagram illustrating the configuration of main parts of a vehicle position estimation apparatus 50 according to the present embodiment. The vehicle position estimation apparatus 50 includes a map information generation apparatus 51 according to the present embodiment. In order to avoid complications, the configuration of the vehicle position estimation apparatus 50 will be described below on the assumption that the subject vehicle travels in the manual drive mode, generates an environment map, and then travels in the self-drive mode with reference to the environment map. The map information on the environment map including landmark information is thus generated while the subject vehicle travels in the manual drive mode.

The vehicle position estimation apparatus 50 is included in the vehicle control system 100 in FIG. 1. As illustrated in FIG. 3, the vehicle position estimation apparatus 50 has a camera 1a, a sensor 2a and a controller 10.

The camera 1a is a monocular camera having an imaging element (image sensor) such as a CCD or a CMOS, and constitutes a part of the external sensor group 1 in FIG. 1. The camera 1a may be a stereo camera. The camera 1a is attached to, for example, a predetermined position in the front portion of the subject vehicle 101, continuously captures an image of a space in front of the subject vehicle 101, and acquires an image (camera image) of a target object. As illustrated in FIG. 2A, an object imaged by the camera 1a includes a shadow portion in addition to the streetlight, the building, the sidewall of a road, and the division line. That is, a material from which an edge indicating an outline can be extracted based on information on luminance and color of each pixel of a camera image, is the object.

The sensor 2a is a detection part used to calculate a movement amount and a movement direction of the subject vehicle 101. The sensor 2a is a part of the internal sensor group 2, and includes, for example, a vehicle speed sensor and a yaw rate sensor. That is, the controller 10 (for example, a subject vehicle position recognition unit 13 in FIG. 1) calculates the movement amount of the subject vehicle 101 by integrating a vehicle speed detected by the vehicle speed sensor, and calculates a yaw angle by integrating the yaw rate detected by the yaw rate sensor. Further, while the vehicle travels in the manual drive mode, the controller 10 estimates the position of the subject vehicle by odometry when the environment map is created. Note that the configuration of the sensor 2a is not limited thereto, and the position of the subject vehicle may be estimated using information of other sensor. A positioning sensor for detecting the position of the subject vehicle also includes in the sensor 2a. The controller 10 in FIG. 3 has a landmark recognition unit 171, a landmark determination unit 172, an information adding unit 173 and a position estimation unit 131, as a functional configuration of a processing unit 11 (FIG. 1). Since the landmark recognition unit 171, the landmark determination unit 172 and the information adding unit 173 have a map generation function, these are included in the map generation unit 17 in FIG. 1. Since the position estimation unit 131 has a function for recognizing the subject vehicle position, it is included in the subject vehicle position recognition unit 13.

The landmark recognition unit 171 recognizes a landmark around the subject vehicle based on the camera image captured by the camera 1a during traveling in the manual drive mode. For example, the landmark recognition unit 171 determines whether or not the camera image includes the landmark by performing processing of pattern matching between various landmark images preliminarily stored in the memory unit 12. The landmark recognition unit 171 makes the determination simultaneously with generation of an environment map including three-dimensional point group data on the surroundings of the subject vehicle. When determining that the camera image includes the landmark, the landmark recognition unit 171 recognizes the position and type (outline) of the landmark on the environment map based on the camera image. The environment map includes the landmark information, and the memory unit 12 stores the landmark information.

The landmark recognition unit 171 recognizes the landmark each time the subject vehicle travels through the point even when the subject vehicle travels again through the point where the subject vehicle has once traveled. As illustrated in FIGS. 2A and 2B, the memory unit 12 thus stores the landmarks recognized in different time zones (e.g., daytime and nighttime) together with time information. For convenience, a landmark recognized during past traveling is referred to as a past landmark, and a landmark recognized during present traveling is referred to as a present landmark below. The memory unit 12 also stores a past travel route of the subject vehicle as part of the travel history information based on a signal from the sensor 2a (e.g., positioning sensor). The past landmark and the present landmark are not acquired in the same time zone, but acquired in different time zones such as daytime and nighttime. The time zone refers to a certain period of time from a certain time to a certain time in a day, for example, a period of time of one hour or more. The different time zones refer to not only daytime and nighttime but time zones with intermediate times that are different from each other by at least several hours, such as morning and afternoon.

The landmark determination unit 172 determines whether or not the subject vehicle is presently traveling on a travel route on which the subject vehicle traveled in the past, that is, whether or not the subject vehicle is presently traveling on a travel route, for which landmark information has already been stored, in a time zone different from the stored time zone. When determining that the subject vehicle is traveling on the travel route, for which landmark information has already been stored, the landmark determination unit 172 determines whether or not a landmark recognized by the landmark recognition unit 171 in the past (past landmark) is still recognized by the landmark recognition unit 171. For example, when the subject vehicle is traveling at night through a point where the subject vehicle traveled during the day, the landmark determination unit 172 determines whether or not the landmark recognition unit 171 recognizes a past landmark recognized during the daytime traveling as a present landmark at night.

The landmark determination unit 172 makes the determination by the following procedure, for example. First, the landmark determination unit 172 identifies a present position with the sensor 2a (positioning sensor). The landmark determination unit 172 reads, from the memory unit 12, an image of a landmark around the present position (landmark having information on position around present position), that is, an image of a past landmark of a matching candidate. The landmark determination unit 172 determines whether or not the read image of the past landmark matches the image of the present landmark recognized by the landmark recognition unit 171. Specifically, when an image matching rate is a predetermined value (e.g., 90%) or more, the landmark determination unit 172 determines that the past landmark matches the present landmark match.

The information adding unit 173 adds predetermined information to the landmark recognized by the landmark recognition unit 171 in accordance with the determination result of the landmark determination unit 172. That is, when the landmark determination unit 172 determines that a past (e.g., daytime) landmark matches a present (e.g., nighttime) landmark, the landmark can be always recognized regardless of a time zone. In this case, the information adding unit 173 adds information indicating that the past landmark can be used without limitation of a time zone, that is, non-limiting information. Strictly speaking, even though the same landmark can be recognized both in a past time zone and in a present time zone different from the past time zone, the landmark cannot necessarily be recognized throughout the day. For ease of explanation, however, the landmark is treated as being recognizable throughout the day.

In contrast, when the landmark determination unit 172 determines that the past and present landmarks do not match each other, that is, that there is no present landmark that matches the past landmark, the past landmark can be recognized only in a predetermined time zone. In this case, the information adding unit 173 adds information indicating that the past landmark can be used with limitation of a time zone, that is, limiting information. The limiting information includes information on a time zone in which the past landmark can be used, that is, information on a time zone in which the past landmark has been recognized (e.g., daytime).

A pattern in which the past landmark does not match the present landmark includes a case where there is no past landmark that matches the present landmark. In this case, the information adding unit 173 adds the limiting information indicating that the present landmark can be used with limitation of a time zone. The limiting information includes information on a time zone in which the present landmark can be used, that is, information on a time when the present landmark is recognized (e.g., nighttime).

The position estimation unit 131 estimates the self-position based on a landmark during traveling in the self-drive mode. That is, the position estimation unit 131 identifies a landmark in a camera image by comparing landmark image information preliminarily stored in the memory unit 12 with information on an image captured by the camera 1a during traveling. The position estimation unit 131 recognizes the subject vehicle position based on the position of the landmark. In this case, a landmark to which non-limiting information is added among landmarks stored in the memory unit 12 is used to estimate the subject vehicle position regardless of the time zone during traveling in the self-drive mode.

In contrast, in the case of the landmark to which the limiting information is added, the position estimation unit 131 determines whether or not the present time is included in the time zone in which the landmark can be used (time zone identified by time information stored in memory unit 12). When determining that the present time is included in the time zone in which the landmark can be used, the position estimation unit 131 estimates the subject vehicle position based on the landmark. In contrast, when determining that the present time is not included in the time zone in which the landmark can be used, the position estimation unit 131 estimates the subject vehicle position without using the landmark based on another landmark or by another method. As a result, the subject vehicle position is estimated without being based on an unclear landmark, so that the accuracy of estimating the subject vehicle position is improved.

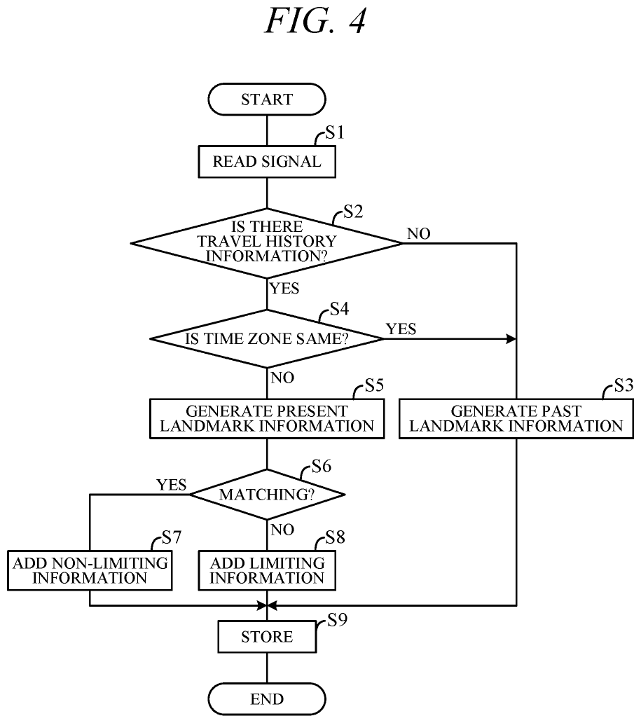

FIG. 4 is a flowchart illustrating one example of processing executed by a controller 10 in FIG. 3 in accordance with a predetermined program, particularly one example of processing regarding map information generation. The processing in the flowchart is started, for example, during traveling in the manual drive mode, and is repeated at a predetermined cycle as long as map information is generated (e.g., while traveling in the manual drive mode continues).

As illustrated in FIG. 4, first, in S1 (S: processing step), a signal is read from the camera 1a and the sensor 2a. In S2, the present position (present point) of a subject vehicle is identified based on the signal from the sensor 2a, and it is determined whether or not the subject vehicle traveled through the present point in the past. That is, it is determined whether or not the memory unit 12 stores travel history information corresponding to the present point of the subject vehicle. When a negative determination is made in S2, the processing proceeds to S3. In this case, the present point is included in the first travel route. In S3, a landmark around the subject vehicle is recognized based on a camera image, and landmark information is generated. The processing then proceeds to S9. The landmark information generated in S3 corresponds to past landmark information in repetitive processing.

In contrast, when a positive determination is made in S2, the processing proceeds to S4. It is determined whether or not the time zone of a travel history stored in the memory unit 12 is the same as the present time zone. That is, it is determined whether or not the subject vehicle is traveling in the same time zone as that at the time when the past landmark information is obtained. For example, when the time zone in which the past landmark information has been obtained in S3 is daytime, and the present time zone is also daytime, a positive determination is made in S4, and the processing proceeds to S3. In this case, the past landmark information is updated based on the camera image. When a positive determination is made in S4, S3 may be skipped to end the processing.

For example, when the present time zone is nighttime, a negative determination is made in S4, and the processing proceeds to S5. In S5, a landmark around the subject vehicle is recognized based on a camera image, and landmark information is generated. The generated landmark information is landmark information in a time zone when landmark information was not generated in the past, and is present landmark information.

In S6, it is determined whether or not the present landmark recognized in S5 matches a past landmark stored in the memory unit 12 in advance at the same point as the present point. In other words, it is determined whether or not there is a present landmark image that matches a past landmark image. When a plurality of past landmark images at the same point as the present point is obtained, the determination is made for each of the plurality of past landmarks. For example, the determination is made for each of the division line, the sidewall, the streetlight, the building, and the shadow in FIG. 2A. When a positive determination is made in S6, the processing proceeds to S7. When a negative determination is made, the processing proceeds to S8. In S6, when there is a plurality of present landmarks at the present point, it is also determined whether or not there is a past landmark that matches each of the present landmarks.

In S7, non-limiting information indicating that a landmark can be used without limitation of a time zone is added to information on any of a past landmark and a present landmark (e.g., past landmark information), and the processing proceeds to S9. In contrast, in S8, limiting information indicating that the landmark can be used with limitation of a time zone is added to the past landmark information, and the processing proceeds to S9. When there is no past landmark that matches the present landmark, the limiting information is added to information on the present landmark, and the processing proceeds to S9.

In S9, the past landmark information generated in S3, information on any of the past landmark and the present landmark (e.g., past landmark) to which the non-limiting information is added in S7, and the past landmark information to which the limiting information is added in S8 or the present landmark information are stored, and the processing ends.

The operation of the vehicle position estimation apparatus 50 according to the present embodiment is summarized as follows. The subject vehicle preliminarily travels in the manual drive mode in order to generate map information. For example, when the subject vehicle travels through a certain point during the day for the first time, the landmarks are recognized around the subject vehicle by the camera image (daytime image 200A) as illustrated in FIG. 2A (S3). Specifically, the division line, the sidewall, the streetlight, the building, and the shadow are recognized by the division line image 201, the sidewall image 202, the streetlight image 203, the building image 204, and the shadow image 205, respectively.

When the subject vehicle travels again through the point at night, the landmarks are recognized around the subject vehicle by the camera image (nighttime image 200B) as illustrated in FIG. 2B (S5). Specifically, the division line and the sidewall are recognized by the division line image 201 and the sidewall image 202, respectively. In this case, although the daytime image 200A and the nighttime image 200B are images at the same point, the landmark recognized during the day and the landmark recognized at night are partially common and partially different. The non-limiting information is added to the landmarks (division line and sidewall) recognized both during the day and at night (S7). The limiting information is added to the landmarks (streetlight, building, and shadow) recognized only during the day or a landmark recognized only at night (S8).

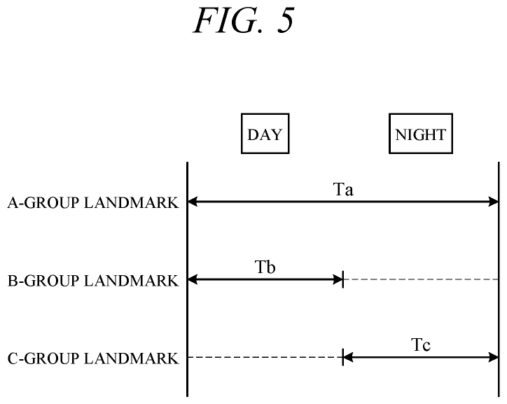

The non-limiting information and the limiting information include time information on a landmark that can be used for estimating a subject vehicle position. FIG. 5 illustrates time information to be added to a landmark information, which is generated by the map information generation apparatus 51 according to the present embodiment. The memory unit 12 stores the time information.

In FIG. 5, A-group landmark can be used throughout the day and night (time zone Ta) For example, the A-group landmark includes the division line and the sidewall in FIGS. 2A and 2B. B-group landmark can be used in a time zone of daytime (time zone Tb) For example, the B-group landmark includes the streetlight, the building, and the shadow in FIG. 2A. C-group landmark can be used in a time zone of nighttime (time zone Tc). For example, the C-group landmark includes a shadow generated by the streetlight. For convenience, although the time zone Tb of the B-group landmark and the time zone Tc of the C-group landmark are illustrated as not overlapping each other in FIG. 5, the time zone Tb may overlap the time zone Tc. The time zones Tb and Tc are not necessarily continuous with each other. Another time zone may be provided between Tb and Tc.

The vehicle position estimation apparatus 50 uses the landmark information stored in the memory unit 12 when estimating the subject vehicle position during traveling in the self-drive mode. In this case, the vehicle position estimation apparatus 50 first determines the present position. The vehicle position estimation apparatus 50 estimates the subject vehicle position based on the landmark information on the A-group landmark and the B-group landmark, for example, during daytime traveling. The vehicle position estimation apparatus 50 estimates the subject vehicle position based on the landmark information on the B-group landmark and the C-group landmark during traveling at night. As described above, the vehicle position estimation apparatus 50 estimates the subject vehicle position based on the landmarks that can be clearly recognized both during the day and at night, so that the vehicle position estimation apparatus 50 can accurately estimate the subject vehicle position.

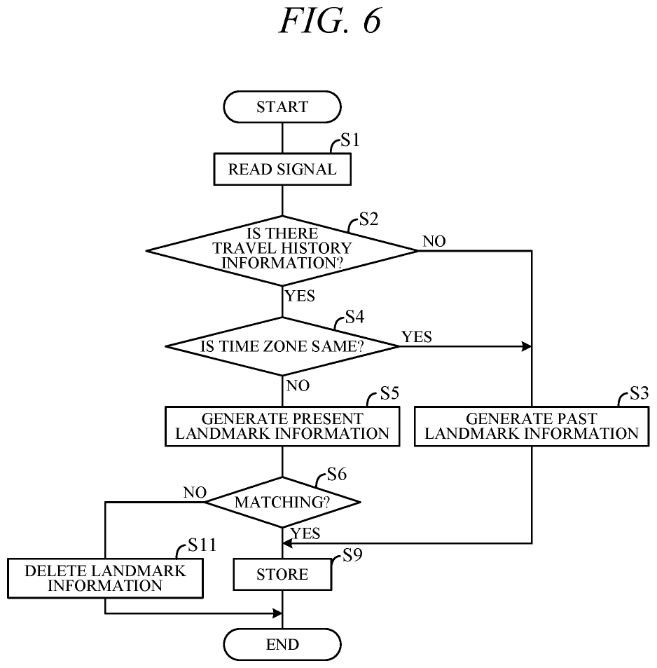

FIG. 6 is a flowchart illustrating a variation of FIG. 4. FIG. 6 is different from FIG. 4 in the processing after determining, in S6, whether or not matching is achieved. That is, in the example in FIG. 6, when a negative determination is made in S6, that is, when it is determined that there is no present landmark that matches the past landmark, the processing proceeds to S11. In S11, the information on a past landmark determined not to match the present landmark is deleted, and the processing ends. When there is no past landmark that matches the present landmark, the present landmark information is deleted, and the processing ends. In contrast, when a positive determination is made in S6, the processing proceeds to S9. The past landmark information generated in S3 is stored as it is, and the processing ends.

In the example of FIG. 6, information on the B-group landmark and the C-group landmark, which cannot be used depending on a time zone, among the A-group landmark, the B-group landmark, and the C-group landmark in FIG. 5 is deleted (S11). The vehicle position estimation apparatus 50 estimates the subject vehicle position based on the information on the A-group landmark when estimating the subject vehicle position during traveling in the self-drive mode. As described above, the vehicle position estimation apparatus 50 estimates the subject vehicle position based on the landmarks (A-group landmark) that can be clearly recognized regardless of a time zone, so that the vehicle position estimation apparatus 50 can accurately estimate the subject vehicle position.

According to the present embodiment, the following function effects can be achieved.

(1) The map information generation apparatus 51 according to the present embodiment generates map information including information on a landmark. The map information generation apparatus 51 includes a camera 1a, a landmark recognition unit 171, a landmark determination unit 172, and a memory unit 12 (FIG. 3). The camera 1a detects an external situation around a subject vehicle. The landmark recognition unit 171 recognizes a past landmark around the subject vehicle based on information on the external situation detected by the camera 1a in a first time zone (e.g., daytime). The landmark determination unit 172 determines whether or not the past landmark recognized by the landmark recognition unit 171 is recognized based on information on the external situation detected by the camera 1a in a second time zone (e.g., nighttime) different from the first time zone. The memory unit 12 stores information on the past landmark recognized by the landmark recognition unit 171 in accordance with the determination result of the landmark determination unit 172. This configuration causes map information to be generated in consideration of the fact that a landmark-recognizable time zone may change. Map information useful for estimating the subject vehicle position can be generated.

(2) The memory unit 12 stores information on a past landmark recognized by the landmark recognition unit 171 based on the information on the external situation in the first time zone (e.g., daytime) together with time information including the first time zone (FIG. 4). It can be determined in which time zone a past landmark can be effectively used, by adding the time information to past landmark information as described above. Therefore, the information is useful for estimating the subject vehicle position.

(3) The landmark recognition unit 171 further recognizes a present landmark around the subject vehicle based on information on the external situation detected by the camera 1a in the second time zone (e.g., nighttime) (FIG. 4). The memory unit 12 further stores information on the present landmark recognized by the landmark recognition unit 171 based on the information on the external situation in the second time zone together with the time information including the second time zone (FIG. 4). It can be determined in which time zone a newly recognized present landmark can be effectively used, by adding the time information to present landmark information as described above. Therefore, the information is useful for estimating the subject vehicle position.

(4) The memory unit 12 stores information on a past landmark recognized by the landmark recognition unit 171, which is determined as being recognized by the landmark determination unit 172. In other words, information on a landmark (past landmark) that is not determined as being recognized by the landmark determination unit 172 is deleted (FIG. 6). As a result, information on a landmark that is not recognized depending on a time zone is deleted, so that the storage capacity can be reduced.

(5) The vehicle position estimation apparatus 50 according to the present embodiment includes the above-described map information generation apparatus 51 and a position estimation unit 131 (FIG. 3). The position estimation unit 131 estimates a subject vehicle position based on map information (landmark information) generated by the map information generation apparatus 51. As a result, even when different landmarks are recognized depending on a time zone, the subject vehicle position can be accurately estimated by using the landmark information.

The above-described embodiment can be varied into various forms. Some variations will be described below. Although, in the above-described embodiment, the external situation of the subject vehicle is detected by an external sensor group 1 such as the camera 1a, a detection device may have any configuration as long as the detection device detects the external situation for generating a map. The external situation may be detected by a LiDAR and the like instead of or together with the camera 1a. Although, in the above-described embodiment, the landmark recognition unit 171 recognizes a landmark around the subject vehicle based on information on the external situation detected by the camera 1a in the first time zone (daytime) and the second time zone (nighttime), the first time zone and the second time zone are not limited to the above-described time zones. The first time zone may be nighttime, and the second time zone may be daytime. The first time zone may be time zone in the morning, and the second time zone may be time zone in the afternoon. That is, as long as the time zones are different from each other, any of the first time zone and the second time zone may be adopted.

Although, in the above-described embodiment, the landmark determination unit 172 determines whether or not a landmark recognized in the first time zone is also recognized in the second time zone by determining whether or not the matching level of landmark images is equal to or greater than a predetermined value, the configuration of a landmark determination unit is not limited to the above-described configuration. In the above-described embodiment, information on a landmark recognized by the landmark recognition unit 171 is stored in accordance with the determination result of the landmark determination unit 172. That is, although a memory stores landmark information after the non-limiting information or the limiting information (time information) is added to the landmark information, or deletes some landmarks, which have not been determined to be recognized, to store the remaining landmark information, the memory may store another piece of information. Although, in the above-described embodiment, the position estimation unit 131 estimates the subject vehicle position based on the landmark information generated by the map information generation apparatus, the subject vehicle position may be estimated based on another piece of map information including the landmark information.

In the above embodiment, the example in which the self-driving vehicle includes the map information generation apparatus has been described. That is, the example in which the self-driving vehicle generates the environment map has been described. However, the present invention can be similarly applied to a case where a manual driving vehicle having or not having a driving support function generates the map information including information on a landmark.

The present invention can also be used as a map information generation method generating a map information including an information on a landmark. That is, the present invention can be used as the map information generation method including recognizing a landmark around the subject vehicle, based on an information on an external situation detected by a detection device such as a camera 1a in a first time zone; determining whether the landmark recognized in the first time zone is recognized in a second time zone different from the first time zone, based on the information on the external situation detected by the detection device in the second time zone; and storing the information on the landmark recognized in the first time zone, in accordance with a determination result of whether the landmark recognized in the first time zone is recognized in the second time zone.

The above embodiment can be combined as desired with one or more of the above modifications. The modifications can also be combined with one another.

According to the present invention, it is possible to generate a map information for a vehicle that can accurately estimate a vehicle position.

Above, while the present invention has been described with reference to the preferred embodiments thereof, it will be understood, by those skilled in the art, that various changes and modifications may be made thereto without departing from the scope of the appended claims.

What is claimed is:

1. A map information generation apparatus generating a map information including an information on a landmark,
the map information generation apparatus comprising:
a detection device that detects an external situation around a subject vehicle; and
an electronic control unit including a microprocessor and a memory connected to the microprocessor, wherein
the microprocessor is configured to perform:
recognizing the landmark around the subject vehicle, based on an information on the external situation detected by the detection device in a first time zone; and
determining whether the landmark recognized in the first time zone is recognized in a second time zone different from the first time zone, based on the information on the external situation detected by the detection device in the second time zone, and
the memory is configured to store the information on the landmark recognized in the first time zone, in accordance with a determination result of whether the landmark recognized in the first time zone is recognized in the second time zone.

2. The map information generation apparatus according to claim 1, wherein
the memory stores the information on the landmark recognized in the first time zone, together with a time information including the first time zone.

3. The map information generation apparatus according to claim 2, wherein
the microprocessor is configured to further perform
the recognizing including recognizing the landmark around the subject vehicle, based on the information on the external situation detected by the detection device in the second time zone, and
the memory is configured to further store the information on the landmark recognized in the second time zone, together with a time information including the second time zone.

4. The map information generation apparatus according to claim 1, wherein
the memory is configured to store the information on the landmark recognized in the first time zone, when it is determined that the landmark recognized in the first time zone is recognized in the second time zone.

5. The map information generation apparatus according to claim 1, wherein
the memory stores the information on the landmark recognized in the first time zone, together with an information on the first time zone, when it is determined that the landmark recognized in the first time zone is not recognized in the second time zone.

6. The map information generation apparatus according to claim 1, wherein
the first time zone is one of a daytime and a nighttime, and
the second time zone is another of the daytime and the nighttime.

7. The map information generation apparatus according to claim 1, wherein
the first time zone is a past time zone,
the second time zone is a present time zone, and
the microprocessor is configured to perform
the determining including determining whether the landmark recognized in the past time is recognized in the present time, based on the information on the external situation detected by the detection device in the second time zone.

8. The map information generation apparatus according to claim 1, wherein
the landmark includes a streetlight turning on in a nighttime and turning off in a daytime.

9. A vehicle position estimation apparatus comprising
the map information generation apparatus according to claim 1, wherein
the microprocessor is configured to perform
estimating a position of the subject vehicle based on the map information generated by the map information generation apparatus.

10. A map information generation apparatus generating a map information including an information on a landmark,
the map information generation apparatus comprising:
a detection device that detects an external situation around a subject vehicle; and
an electronic control unit including a microprocessor and a memory connected to the microprocessor, wherein
the microprocessor is configured to function as:
a landmark recognition unit that recognizes the landmark around the subject vehicle, based on an information on the external situation detected by the detection device in a first time zone; and
a landmark determination unit that determines whether the landmark recognized by the landmark recognition unit in the first time zone is recognized in a second time zone different from the first time zone, based on the information on the external situation detected by the detection device in the second time zone, and
the memory stores the information on the landmark recognized by the landmark recognition unit in the first time zone, in accordance with a determination result by the landmark determination unit.

11. The map information generation apparatus according to claim 10, wherein
the memory stores the information on the landmark recognized by the landmark recognition unit in the first time zone, together with a time information including the first time zone.

12. The map information generation apparatus according to claim 11, wherein
the landmark recognition unit further recognizes the landmark around the subject vehicle, based on the information on the external situation detected by the detection device in the second time zone, and
the memory further stores the information on the landmark recognized by the landmark recognition unit in the second time zone, together with a time information including the second time zone.

13. The map information generation apparatus according to claim 10, wherein
the memory stores the information on the landmark recognized by the landmark recognition unit in the first time zone, when it is determined by the landmark determination unit that the landmark recognized in the first time zone is recognized in the second time zone.

14. The map information generation apparatus according to claim 10, wherein
the memory stores the information on the landmark recognized by the landmark recognition unit in the first time zone, together with an information on the first time zone, when it is determined by the landmark determination unit that the landmark recognized in the first time zone is not recognized in the second time zone.

15. The map information generation apparatus according to claim 10, wherein
the first time zone is one of a daytime and a nighttime, and
the second time zone is another of the daytime and the nighttime.

16. The map information generation apparatus according to claim 10, wherein
the first time zone is a past time zone,
the second time zone is a present time zone, and
the landmark determination unit determines whether the landmark recognized by the landmark recognition unit in the past time is recognized in the present time, based on the information on the external situation detected by the detection device in the second time zone.

17. The map information generation apparatus according to claim 10, wherein
the landmark includes a streetlight turning on in a nighttime and turning off in a daytime.
